(19) United States
(12) Patent Application Publication
(10) Pub. No.: US 2005/0242038 A1
(43) Pub. Date: Nov. 3, 2005

(54) Novel stationary phases for use in high-performance liquid chromatography

(76) Inventor: Wu Chen, Newark, DE (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/837,265

(22) Filed: Apr. 30, 2004

(51) Int. Cl. B01D 15/08

(52) U.S. Cl. 210/656; 210/198.2; 210/502.1; 210/679

(57) ABSTRACT

The invention provides novel materials for chromatography and chromatography columns. The invention provides a monofunctional silane chemically bonded to a substrate, the monofunctional silane has two groups, R, and R′, the monofunctional silane being of the form: 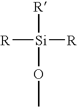 where the R groups are independently selected from the group consisting of alkenyl, alkynyl, and phenyl, R′ is selected form the group consisting of alkyl, substituted alkyl, alkenyl, substituted alkenyl, aryl, substituted aryl, alkylamine, amide, ether, alcohol, cabamate, ester, an anion exchanger, and a cation exchange. Methods for manufacture and design of the columns are also provided and disclosed.

### FIELD OF THE INVENTION

This invention relates to materials for use in chromatography, and the processes for manufacturing the materials. In particular, the invention relates to packing materials for columns for liquid chromatography.

### BACKGROUND OF THE INVENTION

Silica particles are by far the most widely used supports for reversed-phase liquid chromatography stationary phases. The high mechanical stability, monodisperse particles, high surface area, and easily tailored pore size distributions make silica superior to other supports in terms of efficiency, rigidity, and performance. Silica bonding chemistry is also allows for a wide variety of stationary phases with different selectivies to be made on silica [1, 2, 3].

Silanes are the most commonly used surface modifying reagents in liquid chromatography. For example, “An Introduction to Modern Liquid Chromatography,” Chapter 7, John Wiley & Sons, New York, N.Y. 1979; J. Chromatogr. 352, 199 (1986); J. Chromatogr., 267, 39 (1983); and Advances in Colloid and Interface Science, 6, 95 (1976) each disclose various silicon-containing surface modifying reagents. Typical silane coupling agents used for silica derivatization have general formula EtOSiR₁R₂R₃ or ClSiR₁R₂R₃, where R represents organic groups, which can differ from each other or all be the same. For reversed-phase chromatography, the silane coupling agent has traditionally been —Si(CH₃)₂(C₁₈H₃₇), where C₁₈H₃₇, octadecyl group, yields a hydrophobic surface. The reaction, when carried out on the hydroxylated silica, which typically has a surface silanol concentration of approximately 8 μmol/m², does not go to completion due to the steric congestion imposed by the R groups on the coupling agent [3]. To improve the quality of the original chemically bonded phase by blocking access to some residual silanol groups on the silica surface, the bonded phase is usually further endcapped using small organic silanes. The endcapping is usually carried out with compounds able to generate trimethylsilyl groups, (CH₃)₃Si—, the most popular being trimethylchlorosilane (TMCS) and hexamethyldisilazane (HMDS). The majority of free surface silanols, which are under dimethyloctadecylsilyl group, cannot react with the endcapping because of steric hindrance. In the traditional endcapping step, only ˜0.2 μmol/m² surface silanol groups are bonded based on the carbon loading data. The highest coverage attained in laboratory studies has been ˜4.5 μmol/m², while the coverage available in commercial chromatography column is much less, usually on the order 2.7-3.5 μmol/m² even after endcapping [4].

These residual surface silanols interact with basic and acidic analytes via ion exchange, hydrogen bonding and dipole/dipole mechanism. This secondary interaction between analytes and residual silanol groups create problems, including increased retention, excessive peak tailing, especially at mid pH range for basic compounds, and irreversible adsorption of some analytes.

To overcome the problems of residual silanol activity, many methods have been tried such as the use of ultrapure silica, carbonized silica, coating of the silica surface with a polymeric composition, endcapping the residual silanol groups, and addition of suppressors such as long chain amines to the eluent [5]. In practice, none of these approaches is totally satisfactory. A general review of deactivating silica support is given by Stella et al. [Chromatographia (2001), 53, S-113-S115].

One method to eliminate surface silanols by extreme endcapping is described in U.S. Pat. No. 5,134,110. While the traditional endcapping can physically bond some residual silanol groups, at least 50% of the surface silanols remain unreacted. U.S. Pat. No. 5,134,110 describes an endcapping method of octadecyl-silylated silica gel by high temperature silylation [6, 7]. The polymeric chemically bonded phases originated from trichlorosilanes were endcapped using hexamethyldisilazane or hexamethylcyclotrisiloxane at very high temperature, above 250° C., in a sealed ampoule. The resulting endcapped phases were shown to perform excellently on the Engelhardt test. This result was explained by formation of dimethylsilyl loop structures on the surface leading to elimination of silanols. This method had the disadvantage that it was used on a polymeric phase, and polymeric phases usually have poor mass transfer and poor reproducibility. Also the high temperature of silylation in a sealed ampoule is not practical and difficult to perform commercially compared with the traditional liquid phase endcapping procedure.

Another method of reducing the effect of surface silanols is to introduce polar embedded groups in the octadecyl chain. These embedded groups, generally containing nitrogen atoms and amide such as in European Patent Application 90302095.4 [8-12], carbamate such as disclosed in U.S. Pat. No. 5,374,755 [13, 14], and most recently urea groups [15], have shown that they can play an important role to minimize the undesirable silanol interactions. Phases with an incorporated polar group clearly exhibit lower tailing factors for basic compounds, when compared with traditional C18 phases. Some mechanisms have been proposed, while some evidence leads to the belief that the surface layer of an embedded polar group phase should have a higher concentration of water due to the hydrogen bonding ability of the polar groups near the silica surface. This virtual water layer suppresses the interaction of basic analytes with residual surface silanols and permits separation with mobile phase having 100% water [16].

A disadvantage of this approach is that the presence of this water layer seems to contribute to a higher dissolution rate of the silica support when compared to their alkyl C8 and C18 counterparts. In a systematic column stability evaluation by J. Kirkland [17], an embedded amide polar stationary phase was less stable. This result may be predictable, due to the higher water content near the underlying silica surface for polar embedded phases. The embedded polar groups also cause adsorption of some analytes when the phases are hydrolyzed or the phases are not fully reacted during phase preparation [15], leaving amine or hydroxyl groups on the surface. For example, the hydrolyzed amide phase leaves aminopropyl moieties on the surface, and can be strongly adsorb acidic and polar compounds, causing peak tailing or missing.

The polar embedded phases are also more hydrophilic than the traditional C18 phases. The retention of the analytes is much less than on the traditional C18 columns. As a result, the phase selectivity is quite different from traditional C18, which causes to change the order in which analytes elute relative to each other form the column. The method developed on traditional C18 columns cannot be transferred to polar embedded phase columns.

Another method for reducing the effect of surface silanols is to use a phase, which can sterically protect surface silanols. U.S. Pat. No. 4,705,725 to Du Pont describes that bulky diisobutyl (with C18) or isopropyl (with C8, C3, C14 amide) side chain groups (Zorbax™ Stable Bond reversed-phase columns) stabilize both long and short chain monofunctional ligands and protect them from hydrolysis and loss at low pH [18]. The bulky side groups increase the hydrolytic stability of the phase. Such a moiety is less vulnerable to destruction at low pH, and better shields the underlying silanols. The sterically protected phases are extremely stable at low pH. The sterically protected silane phases are not endcapped; therefore, the loss of small, easily hydrolyzed endcapping reagents under acidic mobile phase condition is avoided. At pH<3, the phase has excellent performance in terms of peaks, reproducibility, and lifetime. In this pH range, the silanol groups on a type B silica are nearly completely protonate, and as a result, they do not act as sites for secondary interaction. The coverage density is, however, much lower than for dimethyl ODS phases. The ligand density of diisobutyloctadecyl phase is ˜2 μmol/m² when compared to the related classical dimethyloctadecyl phase with a ligand density of 3.37 mmol/m². U.S. Pat. No. 5,948,531 discloses the use of bridged propylene bidentate silanes or a bidentate C18 phase (Zorbax™ Extend-C18 columns), to restricts analytes to access to residual silanols by incorporating a propylene bridge between two C18 ligands [19]. The bidentate C18 phase retains the benefits of monofunctional silane phases (high column efficiency, reaction repeatability) while demonstrating good stability in high and low pH mobile phases. Zorbax Stable-Bond C18 (SB-C18) and Zorbax Extend-C18 columns also have very similar selectivity to the traditional C18 columns.

Basic compounds appear widely in different areas, such as the environmental, chemical, food, and pharmaceutical industries. In the latter in particular, over 80% of commercialized drugs are estimated to possess a basic function. Therefore, it is of crucial importance to develop practical HPLC stationary phases having minimized surface silanol activity.

The use of unsaturated hydrocarbon groups such as vinyl, allyl, ethynyl, propynyl as side groups and on endcapping reagents for chromatography has not been tried and investigated before. In particular, there is a need to produce a hydrophobic shield on the surface just like dimethyl groups, but also reduce surface silanol activity as seen by dramatically improved peak shapes of basic compounds.

### BRIEF DESCRIPTION OF THE FIGURES

FIG. 1 shows a set of chromatograms comparing the performance of the composition of the invention with other column materials.

FIG. 2 shows chromatograms comparing the performance of the composition of the invention using two different mobile phases.

FIG. 3 shows chromatograms further comparing the performance of the composition of the invention using two different mobile phases.

FIG. 4 shows a chromatogram obtained with the material of the present invention at high pH.

### SUMMARY OF THE INVENTION

The invention provides a silica substrate having a mono-functional silane containing two unsaturated hydrocarbon groups, R, and a functional group, R′, wherein the mono-functional silane is of the form: 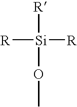
Where, R=alkenyl or alkynyl groups, and R′=alkyl, substituted alkyl, alkenyl, substituted alkenyl, aryl, substituted aryl, alkylamino, amide, ether, carbamate, ester, alcohol; substrate is silica.

The substrate can be bonded to one or more different silanes, and in another embodiment of the invention may be bonded to one group R′ which provides chromatographic functionality to the substrate and also a second reagent which provides an endcapping (i.e. silanol neutralizing) functionality.

The invention also provides a method for making a universal bonded phase. The process comprises preparing divinyl or diallyl alkyl silanes for bonding, bonding silica with diallyl alkyl silanes to produce a bonded phase with vinyl or allyl group on side chains and bonding the residual unbonded silica surface with monovinyl, divinyl, or trivinyl silane.

### DETAILED DESCRIPTION OF THE INVENTION

The present invention provides a substrate, the surface of which is bonded to silanes that provide particular advantages when the support structure is used as a stationary phase for chromatography. The substrate surface is bonded to unsaturated silanes such as those containing alkenyl or alkynyl groups, including vinyl silanes such as trivinyl silane and divinyl silane, or silane with aryl groups. Examples of silanes that can be used as bonding agents include, but are not limited to, chlorotrivinylsilane (i.e., trivinylchlorosilane), chloromethyl divinylsilane, chlorodimethyl vinylsilane, chlorodivlnyloctadecysilane, chlorodivinyloctylsilane, and 3-acryloxypropyl dimethylethoxysilane. The unsaturated silanes for stationary phases and endcapping reagents of the present invention have the following structure: 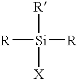
Where, R=alkenyl, alkynyl, or phenyl, for example but not limited to vinyl, allyl, ethynyl, propynyl, or other alkenyl and alkynyl groups; R′=alkyl, substituted alkyl, alkenyl, substituted alkenyl, aryl, substituted aryl, alkylamine, amide, ether, alcohol, cabamate, ester, anion exchanger, cation exchanger; X=Cl, alkoxy such as methoxy, ethoxy, dialkylamino such as dimethylamino, diethylamineo, dipropylamino groups.

The functional group R′ is designed to fit the intended application of the bonded silica. For example, in reversed-phase chromatography carried out in the manner described in Chapter 7 of “Introduction to Modern Liquid Chromatography” (L. R. Snyder and J. J. Kirkland, John Wiley and Sons, New York, 1979) it is desirable for R′ of the silane to consist of alkyl or aryl groups such as C3, C4, n--C8, n--C18, etc., amide such as —(CH₂)₃NHC(═O)R, cabamate such as —(CH₂)₃C(═O)OR, to enable the desired hydrophobic interaction for retention to occur. For ion-exchange chromatography the R′-groups can contain groups with ion-exchange functions, for example, —(CH₂)₃N⁺(CH₃)₃— as an anion-exchanger, and —(CH₂)₃—C₆H₄—SO₃H as a cation-exchanger. For size-exclusion chromatography, particularly for the separation of highly polar, water-soluble biological macromolecules such as proteins, the surface of the substrate are modified with highly polar R′ groups, such as —(CH₂)₃—O—CH(OH)—CHOH, the so-called “diol” function. For hydrophobic interaction chromatography, a weakly hydrophobic stationary phase is desired on the support. For example, R′=methyl-, ethyl-, n-propyl, or isopropyl provide the modest hydrophobic interaction required by this mode of chromatographic retention. In the case of normal-phase chromatography, polar functional groups are incorporated into the silane as R′ groups, for example, —(CH₂)₃—NH₂ and —(CH₂)₃—CN.

The surface of the substrate is bonded to a silane that has one chromatographically effective group as R′, and then is further bonded to one or more silanes for “endcapping” which refers to bonding to further silanes that further improve aspects of the chromatographic performance of the substrate such as peak shape or substrate lifetime under adverse conditions of pH or solvent.

Complete coverage of the substrate by sterically-protecting silane is generally desired. However compete coverage is not always possible and the degree of coverage is largely a function of the population of reactive sites on the substrate and the surface area of the substrate. In the case of fully hydroxylated silica surfaces, about 8 μmol/m² of potentially reactive SiOH groups are present on the surface. However, because of the bulk or steric effects associated with the R- and R′-groups of the sterically-protecting silane, all of these SiOH groups cannot be reacted. In the case of smaller reactants such as chlorotriisopropylsilane, about 1.3 μmol/m² of silane can be covalently bonded to the surface. For sterically larger silanes, even lower concentrations can result.

However, it is not required that a substrate surface by fully covered. In some applications, a low-to-modest concentration of organic ligands is desired on the surface. To achieve this, the reaction is carried out with a less-than-stoichiometric amount of silane relative to the amount that would result for a fully reacted surface. The resulting structures of this invention still exhibit desirable chromatographic properties.

Well known techniques have been developed for attachment of the compounds provided by the invention to the surface of silica. See, for example, U.S. Pat. No. 4,919,804; C. A. Doyle et al., Chromatographic Science Series, 78, 293-323 (1998); U.S. Pat. No. 5,869,724; J. J. Kirkland et al., Anal. Chem., 70, 4344-4352 (1998); J. J. Kirkland et al., Anal. Chem., 61, 2-11 (1989); and K. D. Lork et al., Journal of Chromatography, 352, 199-211 (1986). A general discussion of the reaction of silanes with the surface of chromatographic supports is given in Chapter 7 of “An Introduction to Modern Liquid Chromatography” (L. R. Snyder and J. J. Kirkland, John Wiley and Sons, New York, 1979). Additional details on the reaction of silanes with porous silicas is found starting on page 108 of, “Porous Silica” (K. K. Unger, Elsevier Scientific Publishing Co., New York, 1979). General discussions of silane reactions with a variety of materials are given in, “Chemistry and Technology of silicones” (W. Noll, Academic Press, New York, 1968).

The preparation and performance advantages of the compounds of the present invention can be best understood by reference to the following examples and the figures that are referred to therein.

### EXAMPLE 1

### Preparation of chlorodivinyloctadecylsilane

Octadecylmagnesium chloride in THF (745 ml, 0.5 M) was added into a mixture of dichlorodivinylsilane (50.84 g, 0.332 mole) in THF (400 ml) dropwise at room temperature. After addition, the mixture was stirred at room temperature overnight, and then was heated to reflux for 4 hours. After the reaction was allowed to cool, hexane (400 ml) was added to precipitate the salt. The precipitate was filtered, and washed with hexane (400 ml×3). The solvent was removed by rotary evaporation. The residue was distilled under vacuum (at 205° C./0.4 mm Hg) to yield the desired product, 70 g, yield 57%.

### EXAMPLE 2

### Preparation of (dimethylamino)divinyloctadecylsilane

A four-neck flask was equipped with a mechanic stirrer, two dry-ice condensers. Nitrogen was purge gently through one dry-ice condenser and out from other condenser. Chlorodivinyloctadecylsilane (70 g, 0.189 mole) and hexane (100 ml) were added into the flask. Dimethylamine gas was purged into the system through a dry-ice condenser and was dropped into the mixture. The white precipitate was formed. The reaction was followed by GC. Dimethylamine was continued to purge until the peak of chlorodivinyloctadecylsilane disappeared on GC. The precipitate was filtered and washed with hexane (400 ml×3). Hexane was removed by rotary evaporation. The residue was distilled under vacuum (at 205° C./0.2 mm Hg) to yield the desired product, 58.64 g, yield 82%.

### EXAMPLE 3

### Preparation of endcapping reagent, (dimethylamino)trivinylsilane

(Dimethylamino)trivinylsilane was obtained by the same method as Example 2. A four-neck flask was equipped with a mechanic stirrer, two dry-ice condensers. Nitrogen was purge gently through one dry-ice condenser and out from other condenser. Chlorotrivinylsilane (103 g, 0.713 mole) and hexane (100 ml) were added into the flask. Dimethylamine gas was purged into the system through a dry-ice condenser and was dropped into the mixture. The white precipitate was formed. The reaction was followed by GC. Dimethylamine was continued to purge until the peak of chlorotrivinylsilane disappeared on GC. The precipitate was filtered and washed with hexane (400 ml×3). Hexane was removed by rotary evaporation. The residue was distilled under vacuum (at 22° C./0.4 mm Hg) to yield the desired product, 74 g, yield 68%.

### EXAMPLE 4

### Preparation of Divinyl-C18 Phase

Type B Zorbax Rx-Sil silica support (Rx80) (Agilent Technologies, Wilmington, Del.), and was used for bonding and columns. The physical and surface properties of the highly purified type B Zorbax silica have been previously reported [19]. Surface area for this silica support typically is 180 m²/g, with pore size of 80 Å. Reaction with the silica support was conducted as the same as previous reported [19]. Zorbax Rx80 was dried under vacuum at 110° C. overnight before bonding.

Rx80 Divinyl-C18 before endcapping: Rx80 (142 g, 5 μm, surface area 184 m² μg, 0.209 mole surface silanols) and toluene (350 ml) were charged into a four necked flask, equipped with a mechanic stirrer, a condenser, a Barrette trap, and a thermometer. 30 ml toluene was distilled out and collected in the Barrette trap. After the mixture was allowed cooled to below boiling point, the Barrette trap was removed, and (dimethylamino)divinyloctadecylsilane (58.64 g, 0.155 mole) was added. The mixture was stirred under reflux condition for 2 days. The mixture was filtered while still hot, washed with hot toluene, THF, CH₃CN, and dried at 110° C. under vacuum overnight.

Rx80 Divinyl-C18 endcapped with trivinylsilane (Rx80 Divinyl-C18): Rx80 divinyl-C18 obtained from above (140 g) and toluene (300 ml) were charged into a four necked flask, equipped with a mechanic stirrer, a condenser, a Barrette trap, and a thermometer. 30 ml toluene was distilled out and collected in the Barrette trap. After the mixture was allowed cooled to below boiling point, the Barrette trap was removed, and (dimethylamino)divinyloctadecylsilane (38.62 g, 0.252 mole) was added. The mixture was stirred under reflux condition for 2 days. The mixture was filtered while still hot, washed with hot toluene, THF, CH₃CN, and dried at 110° C. under vacuum overnight.

Table 1 below shows surface coverage comparison of Divinyl-C18 phase with other Dimethyl-C18 phases on the same Zorbax Rx80 particles.

TABLE 1
Surface Coverage Comparison

| | | Phase | Endcapping | Total |
|---|---|---|---|---|
| | | coverage | coverage | coverage |
| Column | % C | (μmol/m²) | (μmol/m²) | (μmol/m²) |
| Rx80 SB-C18 | 10.4 | 2.08 | Not | 2.08 |
| | | | endcapped | |
| Rx80 XDB-C18 | 11.7 | 3.00 | 0.20 | 3.20 |
| Rx80 Extend-C18 | 12.4 | 3.11 | 0.20 | 3.34 |
| Rx80 Divinyl-C18 | 13.0 | 3.15 | 0.15 | 3.30 |

Zorbax Rx80 divinyl-C18 phase has carbon loading of 12.81%, with surface coverage of 3.15 μmol/m², comparable to traditional dimethyl-C18 phase. After endcapped with trivinylsilane, the carbon loading increases to 13.01%. The endcapping coverage is calculated as 0.15 μmol/m², based on the following equation. The total surface coverage is 3.30 mmol/m².

Endcapping surface coverage (μmol/m²)=Δ % C×10⁶/(# of carbon×12×SA), where Δ % C is the carbon loading difference between before endcapping and after endcapping, # of carbon of trivinylsilane is 6, and SA is surface area.

Rx80 SB-C18 packing has the lowest surface coverage. Rx80 XDB-C18, Extend-C18 and Divinyl-C18 have about the same total surface coverage. Changing the side groups from methyl to vinyl seems not to effect the efficiency of bonding. Endcapping coverage using trivinylsilane is little bit less than using trimethylsilane.

### EXAMPLE 5

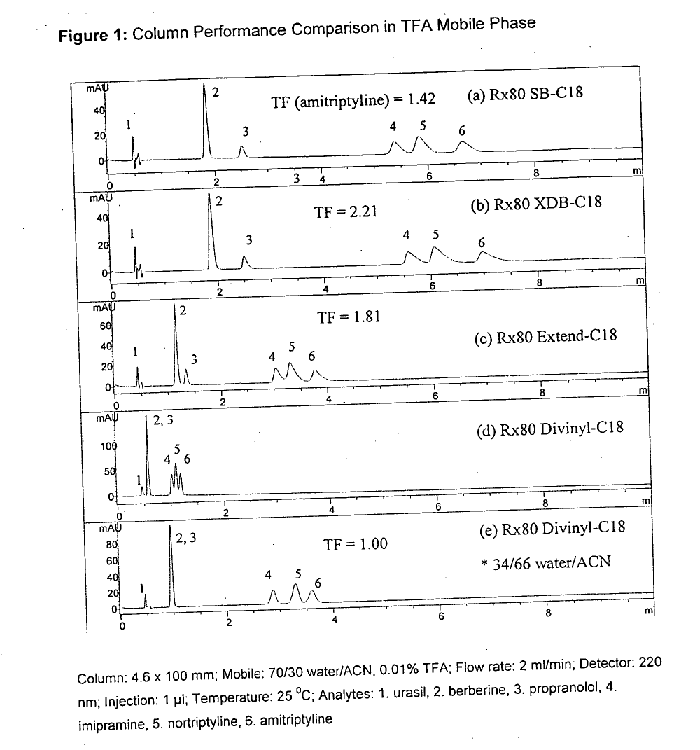

FIG. 1 shows the chromatograms of Rx80 Divinyl-C18 column and other Rx80 C18 columns in a 0.01% TFA water/ACN mobile phase for separation of strong basic compounds. Zorbax Rx80 SB-C18 packing is comprised of a sterically protected C18 phase without endcapping. The phase is designed for high stability at low pH application. Zorbax Rx80 XDB-C18 packing is comprised of a densely bonded dimethyl-silane-substituted C18 phase exhaustively double-endcapped with dimethyl- and trimethylsilane groups by a proprietary process. The phase is designed for mid and high pH application. Zorbax Rx80 Extend-C18 is comprised of a bidentate C18 phase, endcapped as the same as XDB-C18.

Rx80 Divinyl-C18 column has much less retention than other columns, but with the best peak shapes. For example, the tailing factor of amitriptyline on Rx80 Divinyl-C18 column is 1.00 compared with 2.21 on Rx80 XDB-C18 column.

### EXAMPLE 6

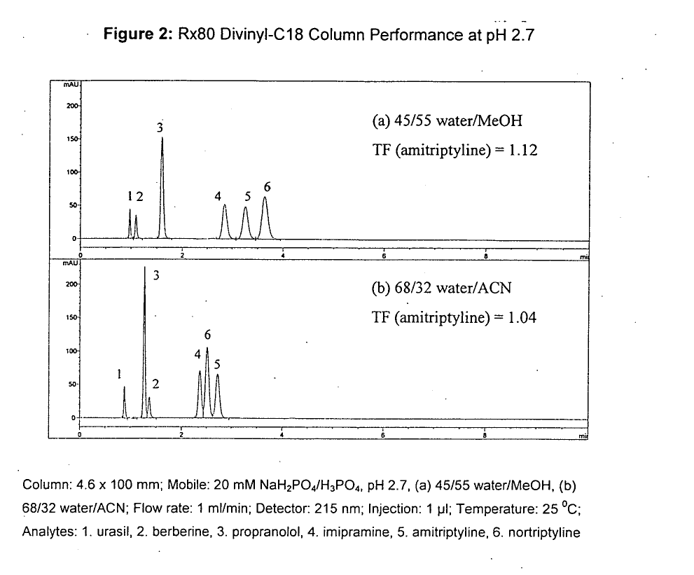

FIG. 2 shows the Rx80 Divinyl-C18 column performance in a 20 mM phosphate mobile phase at pH 2.7. As comparison, Rx80 SB-C18, Rx80 XDB-C18 and Rx80 Extend-C18 columns were evaluated in the same water/MeOH and water/ACN mobile phases. The basic compounds have better peak shapes in a water/MeOH mobile phase than in a water/ACN mobile phase. In the water/ACN mobile phase, the tailing factor difference among these columns is multiplied. Like in 0.01% TFA mobile phase, Rx80 Divinyl-C18 column has the least retention and the best peak shapes. Table 2 summarizes the peak tailing factors of amitriptyline on these columns. The tailing factors of amitriptyline on Rx80 Divinyl-C18 are 1.12 and 1.04 in water/MeOH and water/ACN respectively, much better than on other columns.

TABLE 2
Comparison of the Tailing Factor of Amitriptyline at pH 2.7

| Mobile phase | SB-C18 | XDB-C18 | Extend-C18 | Divinyl-C18 |
|---|---|---|---|---|
| Water/MeOH | 1.16 | 1.49 | 1.46 | 1.12 |
| Water/ACN | 1.24 | 1.97 | 1.85 | 1.04 |

### EXAMPLE 7

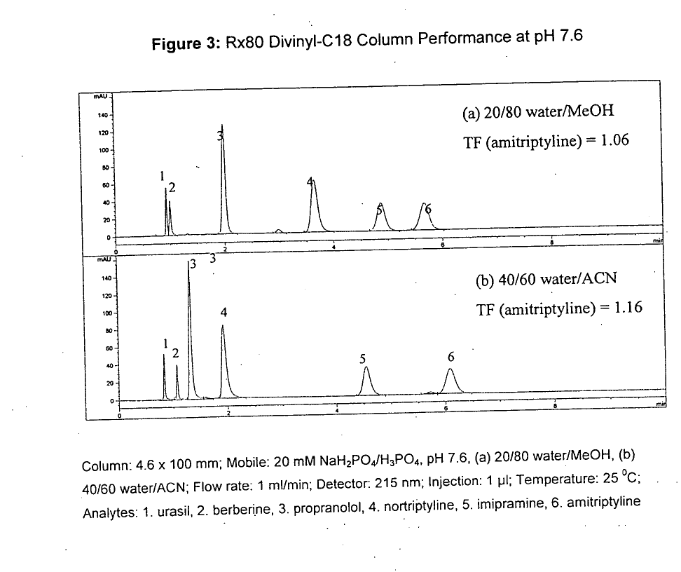

FIG. 3 shows the Rx80 Divinyl-C18 column performance at pH 7.6 in a 20 mM phosphate mobile phase. At pH 7.6, the peaks tend to tail more in water/ACN than in water/MeOH mobile phases. Rx80 Divinyl-C18 column has very similar retention to Rx80 XDB-C18 and Extend-C18. But the peak shapes on Rx80 Divinyl-C18 were improved dramatically. The tailing factors of amitriptyline on Rx80 Divinyl-C18 are 1.06 and 1.16 in water/MeOH and water/ACN respectively, the best among these columns, as shown in Table 3. The tailing factor of amitriptyline in water/ACN on Rx80 Divinyl-C18 is 1.16 compared with 4.93 on Rx80 XDB-C18 column and 2.75 on Rx80 Extend-C18 column.

TABLE 3
Comparison of the Tailing Factor of Amitriptyline at pH 7.6

| Mobile phase | XDB-C18 | Extend-C18 | Divinyl-C18 |
|---|---|---|---|
| Water/MeOH | 1.20 | 1.47 | 1.06 |
| Water/ACN | 4.93 | 2.75 | 1.16 |

### EXAMPLE 8

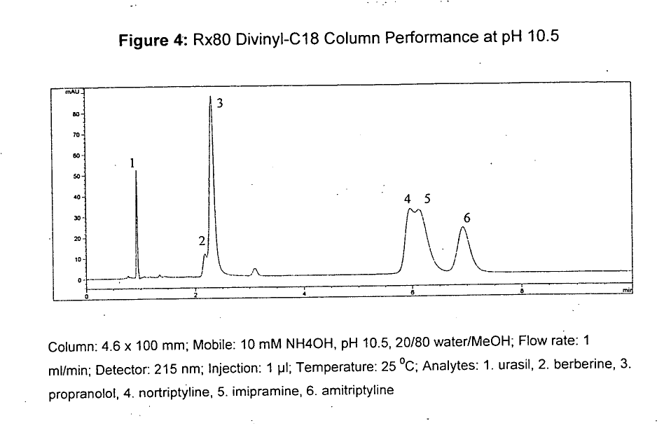

FIG. 4 shows the separation of these basic compounds at pH 10.5 in water/MeOH mobile phase. Separating basic compounds at high pH (>9) as free bases is attractive for routine analyses. Problems of unwanted ionic interactions are minimized as a result of the inability of the free bases to interact by ion-exchange with the totally-ionized, unreacted silanol groups on the silica surface. Although separations at high pH result in excellent peak shapes and column efficiency for basic compounds, chromatographers have been reluctant to use silica-based columns with high pH mobile phase because of questions regarding column stability. Rx80 Extend-C18 column is designed for use at high pH because of its superior stability. Rx80 Divinyl-C18 column performance was evaluated at pH 10.5 in a 10 mM NH₄OH water/MeOH mobile phase against Rx80 XDB-C18 and Extend-C18. The peak shapes on Rx80 Divinyl-C18 column are still the best at pH 10.5. The tailing factors of amitriptyline on Rx80 XDB-C18, Rx80 Extend-C18, and Rx80 Divinyl-C18 columns are 1.30, 1.40, and 1.16 respectively.

The examples show that the material of the invention as a packing for a chromatography column shows a dramatic improvement in the peak shapes of the basic compounds in a range of pH's, especially in water/ACN mobile phase.

1. A substrate comprising a monofunctional silane chemically bonded to the substrate, the monofunctional silane having two groups, R, and R′, and being of the form: 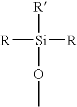
where the R groups are independently selected from the group consisting of alkenyl, alkynyl, and phenyl, R′ is selected form the group consisting of alkyl, substituted alkyl, alkenyl, substituted alkenyl, aryl, substituted aryl, alkylamine, amide, ether, alcohol, cabamate, ester, an anion exchanger, and a cation exchange.

2. The substrate of claim 1, wherein R is selected from the group consisting of vinyl, allyl, ethynyl, and propynyl.

3. The substrate of claim 1, wherein the substrate is selected from the group consisting of a hydrated metal oxide, a hydrated metalloid-oxide, or an organic polymer.

4. The substrate of claim 3, wherein the metal oxide and metalloid oxide substrates comprise silica, chromia and tin oxide.

5. The substrate of claim 3, wherein the substrate is a rigid material coated with silica.

6. The substrate of claim 1, wherein the R groups are different.

7. A substrate for peptide synthesis comprising a silica substrate, and a silane, arranged in the form: 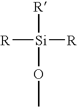
ein R is selected from the group consisting of vinyl, allyl, ethynyl, and propynyl, R′ is —(CH₂)₃—NH₂ and the O moiety is covalently attached to the silica substrate.

8. The substrate of claim 1, wherein R₁ is —CH═CH₂.

9. The substrate of claim 1, wherein the R′ group includes an ion-exchange group.

10. The substrate of claim 1, wherein the R′ group includes a site for attachment of a ligand useful in affinity chromatography.

11. The substrate of claim 1, wherein the R′ group includes a site for attachment of catalysts.

12. The substrate of claim 1, wherein the R′ group provides hydrophobic binding sites suitable for reverse phase chromatography.

13. The substrate of claim 1, wherein the R′-group provides hydrophilic sites suitable for use in size-exclusion chromatography.

14. The substrate of claim 12, wherein the ion-exchange group is a weak anion-exchange, strong anion-exchange, weak cation-exchange or strong cation-exchange group.

15. A method for the chromatographic separation comprising:
(a) applying a sample to a stationary phase, said stationary phase comprising a stable support structure comprising a substrate and a monofunctional silane bonded to the substrate, the monofunctional silane having two sterically-protecting groups, R, and an additional functional group, R₁, and wherein the silane structure is of the form: 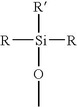
where the R groups are independently selected from the group consisting of alkenyl, alkynyl, and phenyl, R′ is selected form the group consisting of alkyl, substituted alkyl, alkenyl, substituted alkenyl, aryl, substituted aryl, alkylamine, amide, ether, alcohol, cabamate, ester, an anion exchanger, and a cation exchanger.

16. A column for use in chromatographic separations comprising:
a substrate comprising a monofunctional silane, having two sterically-protecting groups, R, and R₁, covalently attached to the substrate, the silane structure is of the form: 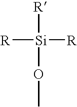
where the R groups are independently selected from the group consisting of alkenyl, alkynyl, and phenyl, R′ is selected form the group consisting of alkyl, substituted alkyl, alkenyl, substituted alkenyl, aryl, substituted aryl, alkylamine, amide, ether, alcohol, cabamate, ester, an anion exchanger, and a cation exchanger.

17. A process for the manufacture of substrate for chromatography, comprising;
(i). preparing divinyl or diallyl alkyl silanes for bonding,
(ii). bonding a silica substrate with the diallyl alkyl silane to produce a bonded phase,
(iii). Bonding at least a fraction of the residual unbonded silica surface with a silane selected form the group consisting of monovinyl, divinyl, and trivinyl silane.
